(19) United States
(12) Patent Application Publication
(10) Pub. No.: US 2014/0047527 A1
(43) Pub. Date: Feb. 13, 2014

(54) System and Method for Detecting and Preventing Automated Interaction Based on Detected Actions Performed by User to Solve a Proffered Puzzle

(71) Applicants: Timothy Ngo, Austin, TX (US); Sean Wade, Houston, TX (US)

(72) Inventors: Timothy Ngo, Austin, TX (US); Sean Wade, Houston, TX (US)

(21) Appl. No.: 13/961,872

(22) Filed: Aug. 7, 2013

Related U.S. Application Data
(60) Provisional application No. 61/680,697, filed on Aug. 7, 2012.

(51) Int. Cl. H04L 29/06

(52) U.S. Cl. CPC H04L 63/08
USPC 726/7

(57) ABSTRACT

A system and method is provided to detect and prevent automated interaction. A server sends a puzzle to a client application of a client device. The puzzle is programmed and configured to enable a user to solve the puzzle with doing one or a series of maneuvers only using an input pointing means and by moving an Actor object displayed in the puzzle along an indicated path to a target location on the path. The server receives from the client application behavior data documenting the user's interactions with the Actor object in the course of trying to solve the puzzle, analyzes the received user behavior data, and decides whether the puzzle is solved and is solved by a human based on the analysis on the behavior data. The server sends to the client application an authentication token when the server decides that the puzzle is solved by a human.

### CROSS-REFERENCE TO RELATED APPLICATION

This application claims the benefit under 35 U.S.C. §119(e) of Provisional Patent Application No. 61/680,697, filed Aug. 7, 2012, the entire disclosure of which is hereby incorporated by reference.

### BACKGROUND

1. Technical Field

The present disclosure generally relates to a system and method for detecting and preventing automated interaction. The present disclosure more particularly relates to a system and method for detecting and preventing automated interaction based on user interactions observed in the user's behavior to solve a puzzle.

2. Description of the Related Art

With the advent of Internet technologies, vicious automated attacks against web sites via Internet also come into existence. Thus, technologies designed to tell computers and humans apart have been developed to combat vicious automated attacks in order to ensure or increase web security. One group of those technologies is generally referred to as CAPTCHA (which stands for “Completely Automated Public test to Tell Computers and Humans Apart”). More recently, CAPTCHA technologies have also been used in advertising. A CAPTCHA-based advertisement is often designed to prevent automated interactions performed by a computer software program to get past the advertisement, so as to either ensure the sponsoring advertiser or increase the confidence thereof that a human, not an automated compute software program, has interacted with the advertisement.

Conventional CAPTCHA systems often produce a negative and frustrating user experience. For example, in some conventional CAPTCHA systems, a known string of text is randomly selected. The text is then distorted through graphic “noise” aimed at making it difficult for automated software to decipher the CAPTCHA text and solve the problem correctly. A user is then challenged to decipher the text and type the message into an input field. Over time, however, CAPTCHA designers have added more “noise” and other distortions as a way to respond to attackers' improved attacking techniques. Unfortunately, while this has made attacks harder, it also makes CAPTCHA text unreadable by human users as well, leading to increased frustration (and in some cases driving users away from more sites using complex CAPTCHA systems).

This type of negative and frustrating user experience often results from the fact that conventional CAPTCHA systems focus exclusively on the “correctness” of a response from a user, but overlooks any behavioral trends—or in simple terms, “how” the user comes up with a correct response—during the interaction between the user and the CAPTCHA that could indicate an automated system.

Therefore, there is a need for a user-friendly system and method for effectively detecting and preventing automated interaction based on not only the “correctness” of a user's response but also behavioral trends of a user observed during the interaction between the user and the system.

### BRIEF SUMMARY

In one aspect, the present disclosure provides a user-friendly graphical puzzle (test) (hereinafter referred to as “AIDAPS puzzle”) created for an automated interaction detection and prevention system (“AIDAPS”), as used either for online security or as a form of advertisement. A user may only get past the AIDAPS puzzle by solving the puzzle. The AIDAPS puzzle is so created that the puzzle, for the most part, only needs a user to do a series of maneuvering of or on an input pointing means (such as a mouse or a touchscreen) so as to tap, move, “slide”, or “drag” a graphical “Actor” object from a starting location to either a target location or a series of target locations in accordance with one or more graphically designated easy-to-understand paths and/or rule(s) provided therein. An AIDAPS puzzle is deemed solved by a human only when the puzzle is deemed solved—which, for example, is when the Actor object has been “dropped” to the target location or to each of a series of target locations (presumably as a result of the user's actions with the input pointing means) in accordance with one or more designated paths and/or one or more indicated rules—and the interactive behavior “recorded” over the course of the puzzle-solving process is analyzed to be the result of actions of a human.

In another aspect, the present disclosure provides a system and method of performing targeted behavior analysis of and/or on the user's behavior profile established over the course of solving an AIDAPS puzzle as integral part of an overall framework to combat automated attacks in testing for humanness.

In yet another aspect, the present disclosure provides a client-server based system and method combining client-side processing and server-side processing performed on an AIDAPS puzzle to achieve detection and prevention of automated interaction.

In yet another aspect, the present disclosure provides a multi-node system and method enabling an operator site to utilize AIDAPS puzzles owned or created by a third-party (such as an AIDAPS site) for the operator site's web security purpose and/or the operator site's revenue-generating advertising purpose.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements may be exaggerated relative to other elements. Embodiments incorporating teachings of the present disclosure are shown and described with respect to the figures presented herein, in which:

FIG. 1 is a general diagram illustrating an exemplary operating environment of the disclosed system and method, according to one or more embodiments of the present disclosure.

FIG. 2 is a block diagram illustrating an exemplary AIDAPS site, according to one or more embodiments of the present disclosure.

FIG. 3 is a block diagram illustrating an exemplary server of operator site, according to one or more embodiments of the present disclosure.

FIG. 4 is a block diagram illustrating an exemplary client device, according to one or more embodiments of the present disclosure.

FIGS. 5A-F are pictorials illustrating exemplary AIDAPS puzzles, according to one or more embodiments of the present disclosure.

FIG. 6 is a flowchart illustrating a process in which an AIDAPS puzzle is employed and behavior data collected during solving of the puzzle is analyzed in testing for humanness before requested content is revealed to a requesting user, according to one or more embodiments of the present disclosure.

FIGS. 7A-G are code snippets exemplifying respective client-side and server-side implementations of an AIDAPS puzzle as well as analysis of a user's behavior data collected in the course of the user's attempting to solve the puzzle, according to one or more embodiments of the present disclosure.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof.

References within the specification to “one embodiment,” “an embodiment,” “embodiments”, and “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, “or” includes “and/or,” and reference to a numerical value includes at least that value, unless the context clearly indicates otherwise. Moreover, the use of the terms first, second, etc. do not denote any order or importance, but rather the terms first, second, etc. are used to distinguish one element from another.

Functional steps illustrated herein, unless otherwise specified as, or logically required to be, performed in accordance with a specific sequence, are presumed to be performable in any order without regard to a specific sequence.

Within the descriptions of the different views of the figures, the use of the same reference numerals and/or symbols in different drawings indicates identical, similar, or close related items, and similar or closely related elements can be provided similar names, reference numerals, and reference alpha-numerals throughout the figures. If a reference numeral is once used to refer to a plurality of like elements, unless required otherwise by context, the reference numeral may refer to any, a subset of, or all of, the like elements in the figures bearing that reference numeral. A reference alpha-numeral (such as “544A”) may refer to one implementation or one portion of one element or a plurality of like elements bearing the same base reference numeral (such as “544”). The specific identifiers/names, reference numerals and reference alpha-numerals assigned to the elements are provided solely to aid in the description and are not meant to imply any limitations (structural or functional or otherwise) on the described embodiments.

In the description, relative terms such as “left,” “right,” “vertical,” “horizontal,” “upper,” “lower,” “top” and “bottom” as well as any derivatives thereof should be construed to refer to the logical orientation as then described or as shown in the drawing figure under discussion. These relative terms are for convenience of description and are not intended to convey any limitation with regard to a particular orientation.

In the present disclosure, the terms “module”, “sub-module”, “application”, “application module”, “software”, “software program”, “software module”, “programmatic module”, “code”, “application code”, “programmatic code”, “object”, “programmatic object”, “script”, “routine”, “service routine”, “function”, “service”, “engine”, “processor”, “component”, and so on, when context allows or requires, may be used interchangeably to refer to one or more sets of computer instructions adapted to perform, when executed by a processor (such as a microprocessor or a microcontroller), one or more specific functions.

### 1. Exemplary Architecture of the Disclosed System and Method

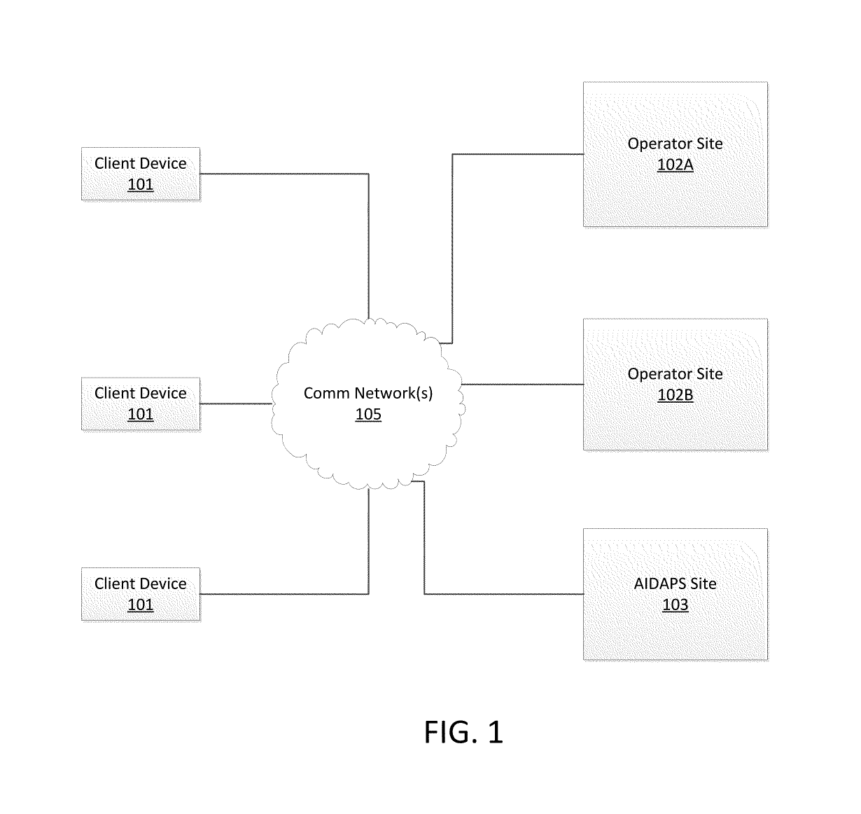

With reference now to the figures, and beginning with FIG. 1, there is depicted a general diagram illustrating an exemplary operating environment of the disclosed system and method, according to one or more embodiments of the present disclosure. Referring to FIG. 1, the operating environment of the disclosed system and method may comprise one or more operator sites 102 (such as operator sites 102A and 102B), an AIDAPS site 103, and a plurality of networking-capable client devices 101. The one or more operator sites 102, AIDAPS site 103 and the plurality of client devices 101 are communicatively coupled to each other through one or more communication networks 105, which may include Internet and/or one or more interconnected networks, such as one or more cellular networks, or one or more local area networks.

An operator site 102 is used by an operating entity to provide contents to users desiring for such contents as part of the operating entity's for-profit or non-profit business. In particular, an operator site 102 may use the disclosed automated interaction detection and prevention (“AIDAP:) service provided by an AIDAPS site 103 to enhance the effectiveness of the operator site's revenue-generating advertising services (as may be requested by advertisers or advertising agencies) and/or the operator site's own online security. In the present disclosure, the term “operator site”, depending on the context in which the term is used, may refer to the backend system of the operator site, the aforementioned operating entity (such as an operator or an operating firm), or a combination of both. Similarly, the term “AIDAPS site”, depending on the context in which the term is used, may refer to the backend system of the AIDAPS site, an operating entity of the AIDAPS site, or a combination of both.

A user may use one or more client devices 101 to communicate with an operator site 102 in order to receive desired content from the operator site 102. A client device may communicate with AIDAPS site 103 without the user's awareness as a result of, e.g., the operator site's use of the AIDAP service from AIDAPS site 103. A client device 101 can be any computing device having networking capabilities and loaded with one or more client applications enabling a user to perform various specific functions. Examples of a client device 101 may include a smart phone, a PC, a notebook computer, a tablet and a PDA. Applications running on a client device 101 are commonly referred to as “apps” when the client device is a smart mobile device such as a smart phone or a tablet PC. As used herein, the term “client application” refers to a software application running on a client device 101.

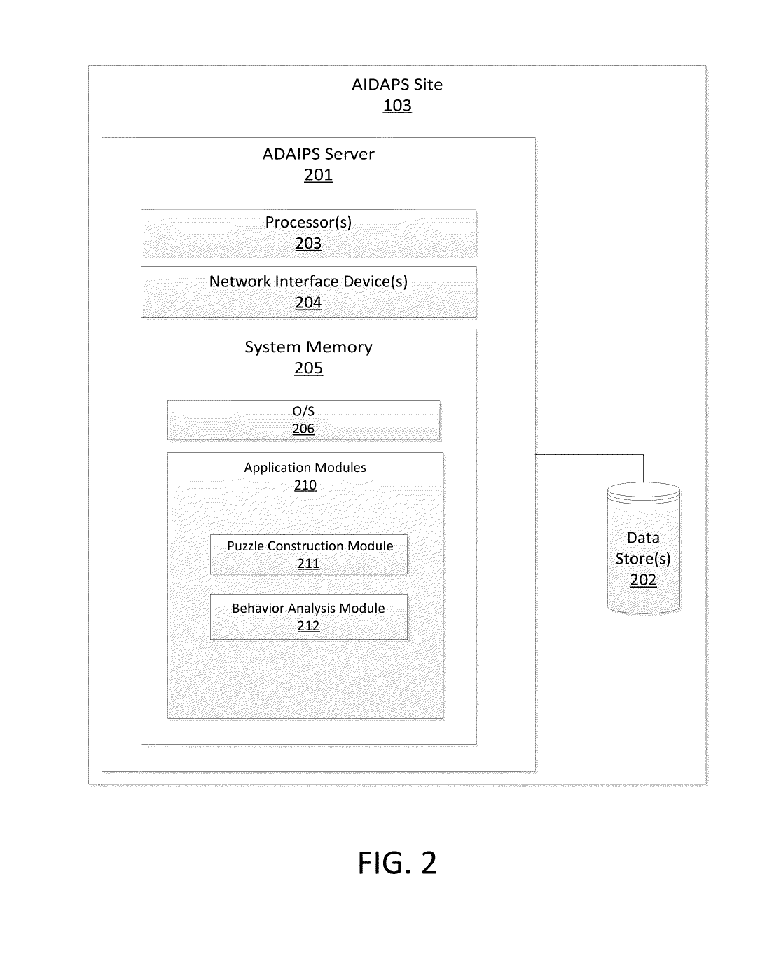

FIG. 2 is a block diagram illustrating AIDAPS site 103 according to one or more embodiments of the present disclosure. Referring to FIG. 2, AIDAPS site 103 may comprise server 201 and data store 202. As used herein, the term “server” refers to any of various types of computing devices, such as computer clusters, server pools, general-purpose personal computers, workstations, or laptops. Server 201 comprises, inter alia, one or more processors 203 (such as one or more microprocessors), one or more network interface devices 204, and one or more system memories 205. During an operation of server 201, software modules or firmware modules, such as operating system 206 and a plurality of application modules 210, are loaded into system memories 205. These software or firmware modules, when executed by one or more processors 203, are adapted to perform various functions for which their respective programmatic (software) codes are programmed.

Data store 202 (hereinafter referred to as “DS 202”) is communicatively coupled to server 201. DS 202 may exist or be implemented in one or more of various forms, such as one or more local or distributed relational or objective databases, one or more local or distributed file systems, one or more removable storages, one or more memory caches, one or more memory clusters, or any combination thereof. In one embodiment, DS 202 resides in server 201. In another embodiment, DS 202 resides external to server 201. DS 202 may be configured to store data needed for providing an AIDAP service, as will be disclosed in more details below.

Application modules 210 may be implemented in various forms, such as standalone executable programs, callable functions and routines, scripts that can be executed via running of one or more interpreter programs, services that may be invoked by standard or proprietary protocols, and programmatic objects containing both data and callable functions.

In one embodiment, application modules 210 may include a puzzle construction module 211 and a behavior analysis module 212. In one implementation, puzzle construction module 211 may be programmed and configured to construct or retrieve an AIDAPS puzzle (for, e.g., either the advertising purpose or the online security purpose) based on received information identifying or specifying an AIDAPS puzzle. A constructed or retrieved AIDAPS puzzle may include both graphical elements and programmatic elements (such as software code). The included software code, when deployed and executed in a client device 101 as a result of the AIDAPS puzzle being transmitted from AIDAPS site 103 to the client device, may be adapted to, inter alia, enable a user to interact with one or more aforementioned graphical elements, collect user behavior data, and perform one-way or two-way communications with AIDAPS site 103 including sending collected user behavior data. The behavior analysis module 212 may be programmed and configured to analyze user behavior data (associated with solving an AIDAPS puzzle) received from a client device so as to determine whether the puzzle is solved and whether the puzzle is solved by a human.

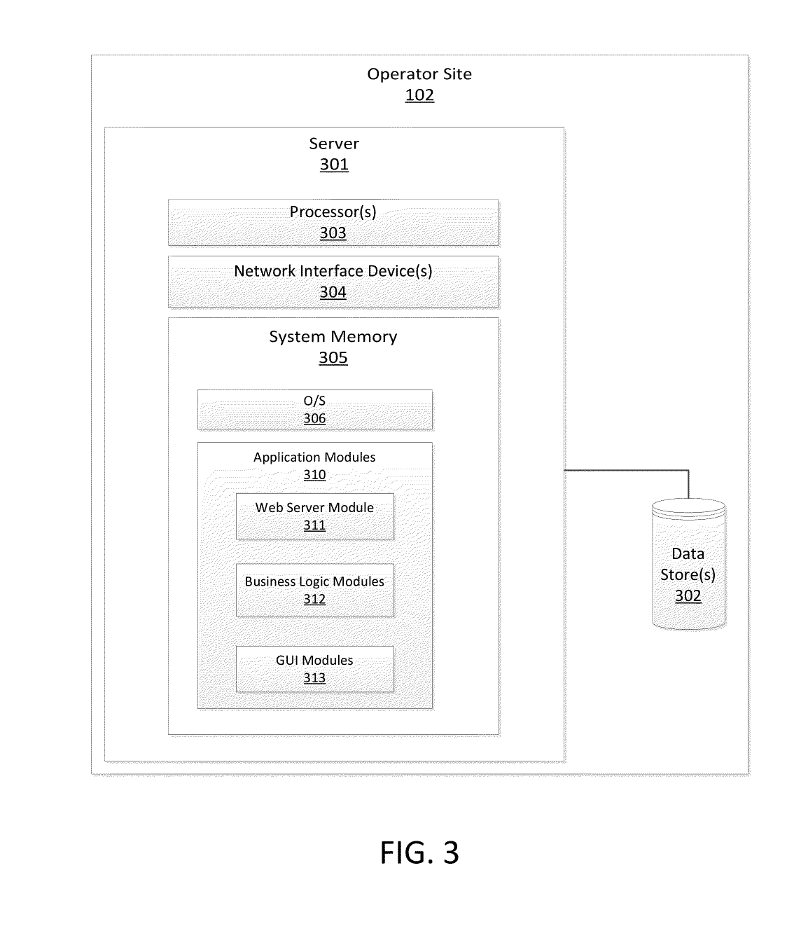

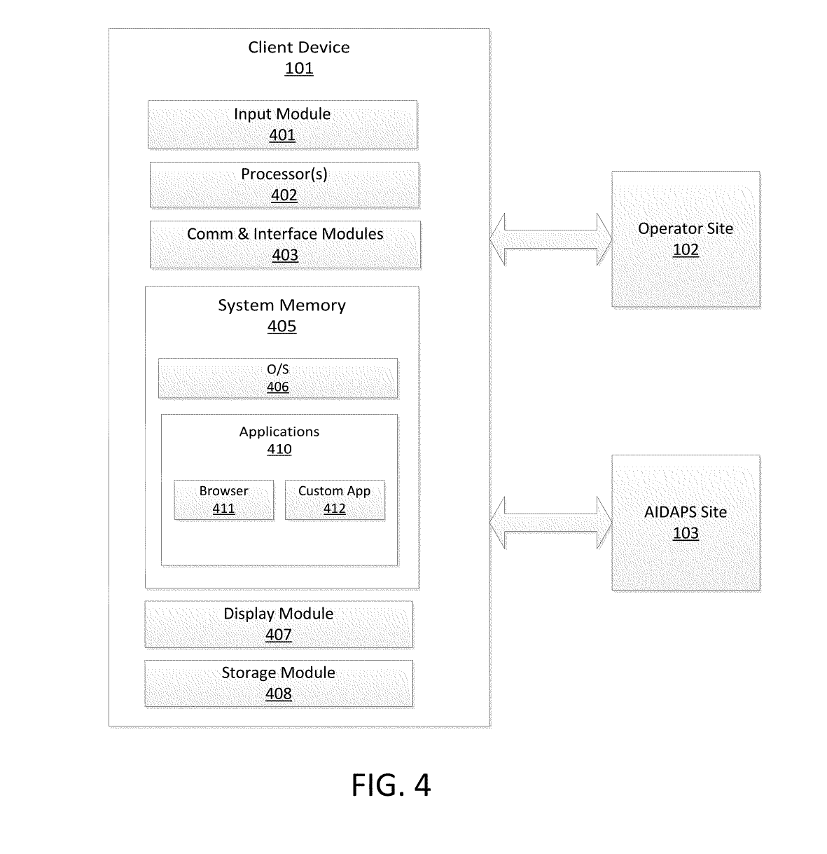

FIG. 3 is a block diagram illustrating an exemplary operator site 102, according to one or more embodiments of the present disclosure. Similar to AIDAPS site 103, an operator site 102 may comprise server 301 and DS 302, which are of similar natures to server 201 and DS 202 of AIDAPS site 103, respectively. More specifically, server 301 comprises, inter alia, one or more processors 303 (such as one or more microprocessors), one or more network interface devices 304, and one or more system memories 305. Operating system 305 and application modules 310 may be loaded into system memories when server 301 is in operation. Application modules 310 may include web server module 311, one or more business logic modules 312, and one or more graphical user interface (GUI) modules 313.

Web server module 311 may be programmed and configured to receive web requests from a client application (such as a web browser) of a client device 101 and delivers a corresponding web response to a client application. Business logic modules 312 may be programmed and configured to implement business logics and functionalities needed by one or more other application modules 210. For example, business logic modules 312 may be programmed and configured to check whether there is a need to use AIDAP service so as to have the client device run an AIDAPS puzzle (for advertising or security purpose) before revealing user-requested content to a user. GUI modules 313 may be programmed and configured to generate specific UI instructions (which may include both presentation semantics and data to be displayed). Thus, for illustration and not limitation, one or more GUI modules 313 may generate UI instructions to render one or more UIs to display contents requested by a user, or one or more UIs along with a loaded AIDAPS puzzle for various purposes. GUI modules 313 may not be needed if a client application used to display UIs for the disclosed system and method is not a browser, but rather an “app” (or, in other words, a custom application) specifically programmed and configured to work in concert with an operator site 102 in regard to UI displays.

FIG. 3 is a block diagram illustrating an exemplary client device, according to one or more embodiments of the present disclosure. A client device, as shown in FIG. 3, can be any computing device having networking capabilities and loaded with one or more client software applications. Examples of a client device may include a smart phone, a PC, a notebook computer, a tablet and a PDA. Referring to FIG. 3, a client device may comprise, inter alia, an input module 401, one or more processors 402, communication and interface modules 403, a system memory 405 (which may include an operating system 406 and client applications 410), a display module 407, and a storage module 408.

Examples of processor 402 include a microprocessor and a microcontroller. The input module 401 receives input from a user and provides the received input to one or more processors for further processing by software programs running in processor 402. The input module may include a keyboard, an input pointing means (such as a mouse, a touchpad, a touch screen, or any combination thereof), input keys, or any combination thereof. Communication and interface modules 403 may provide wired and/or wireless networking capabilities and capabilities of interfacing with other external devices. Communication and interface modules 403 may include one or more communication devices (such as network interface device (NID), an RF unit, and antenna, or any combination thereof) and/or one or more interfacing devices (such as one or more USB connectors), as well as software or firmware modules driving or supporting aforementioned communication and/or interfacing devices. Display module 407 may include one or more display devices, such as an LCD display screen, that is used to display user input data or output data provided by an application running in the shown client device. Display module 407 may include a touch screen which also allows user to input data. In that case, display module 407 may also serve as an input device (particularly an input pointing means) included in input module 401. Storage module 408 may include various internal and external storage media, such as RAM, ROM, hard disk, smart card, flash memory, and any external storage accessible via, e.g., the communication module or an interface module (not shown) of the client device, such as a USB interface.

One or more application modules 410 can be loaded into the system memory during an operation of a client device 101. Client applications are commonly referred to as “apps” when client device 101 is a smart mobile device such as a smart phone or a tablet PC. In one embodiment, client applications may include a web browser 411, which renders HTML pages received from an operator site 102. In another embodiment, client applications may include one or more custom applications 412 as an integral part of the disclosed AIDAP system and method. The one or more custom applications 412, in lieu of or in addition to a web browser 411, are specifically programmed to provide custom user interfaces (Uls) adapted to display and run an AIDAPS puzzle. A custom application 412 may exist in various forms. For example, a custom client application 412 may be a standalone application running in a smart phone, a tablet, PC or notebook computer. A custom application 412 may also be a software module running inside a specific application context, such as a so-called “Facebook app” running inside a Facebook context (a social networking context), or either a Java applet or an ActiveX control running inside a browser 411.

### 2. Exemplary AIDAPS Puzzles

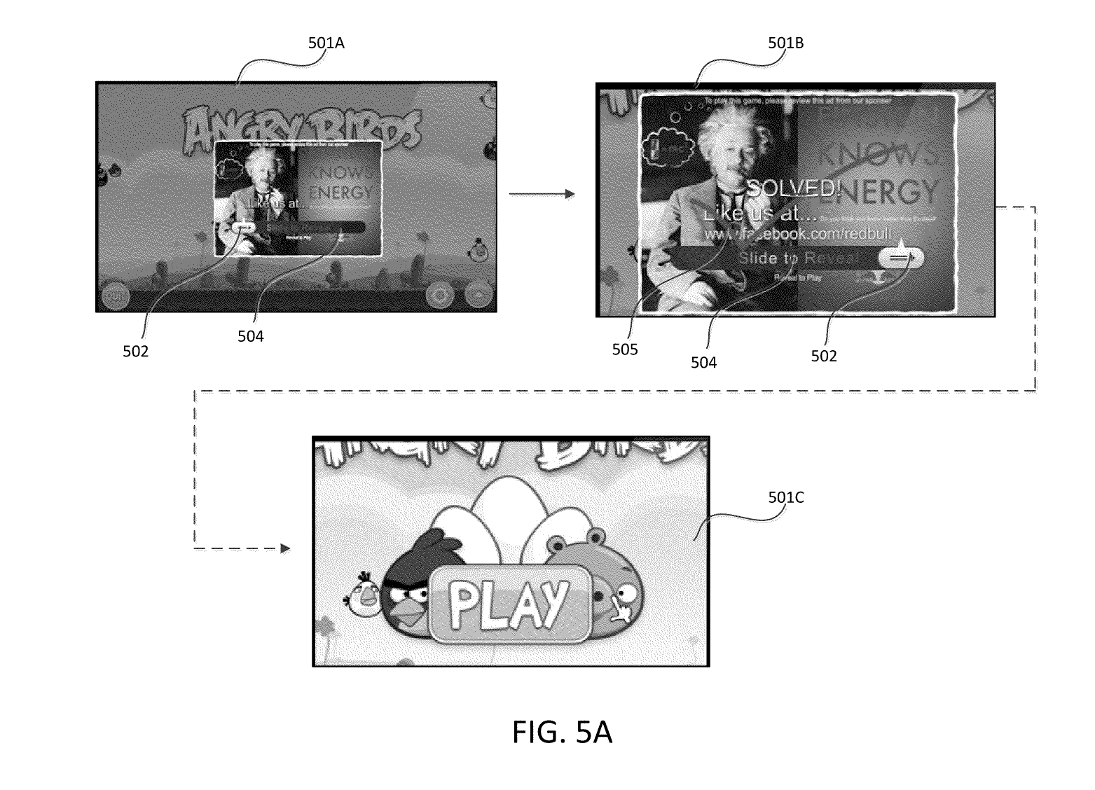

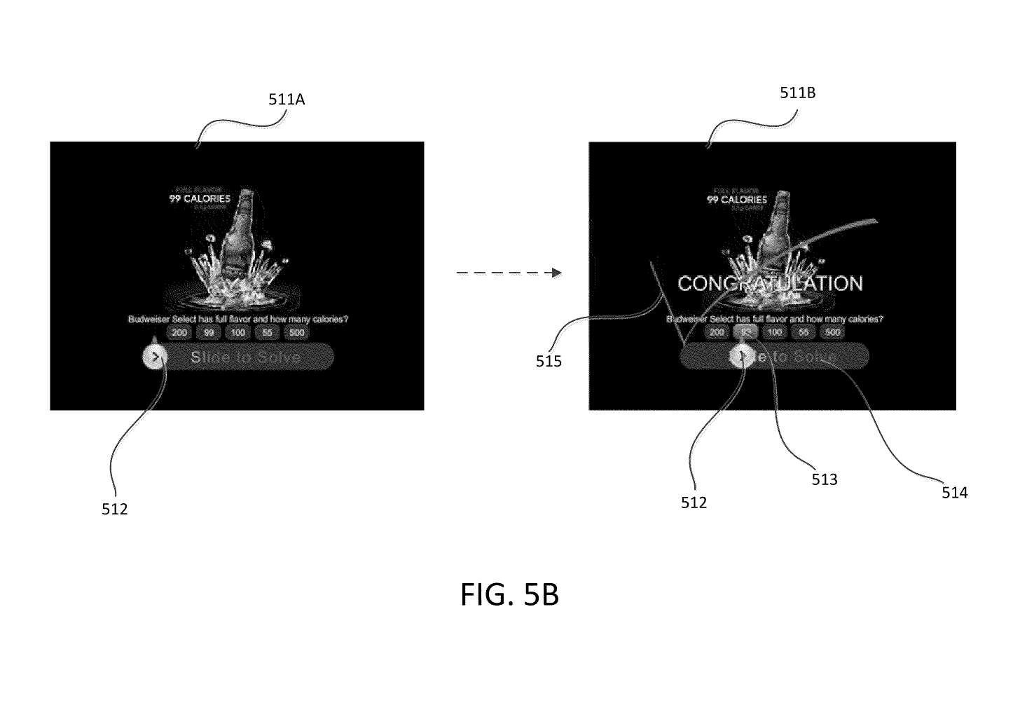

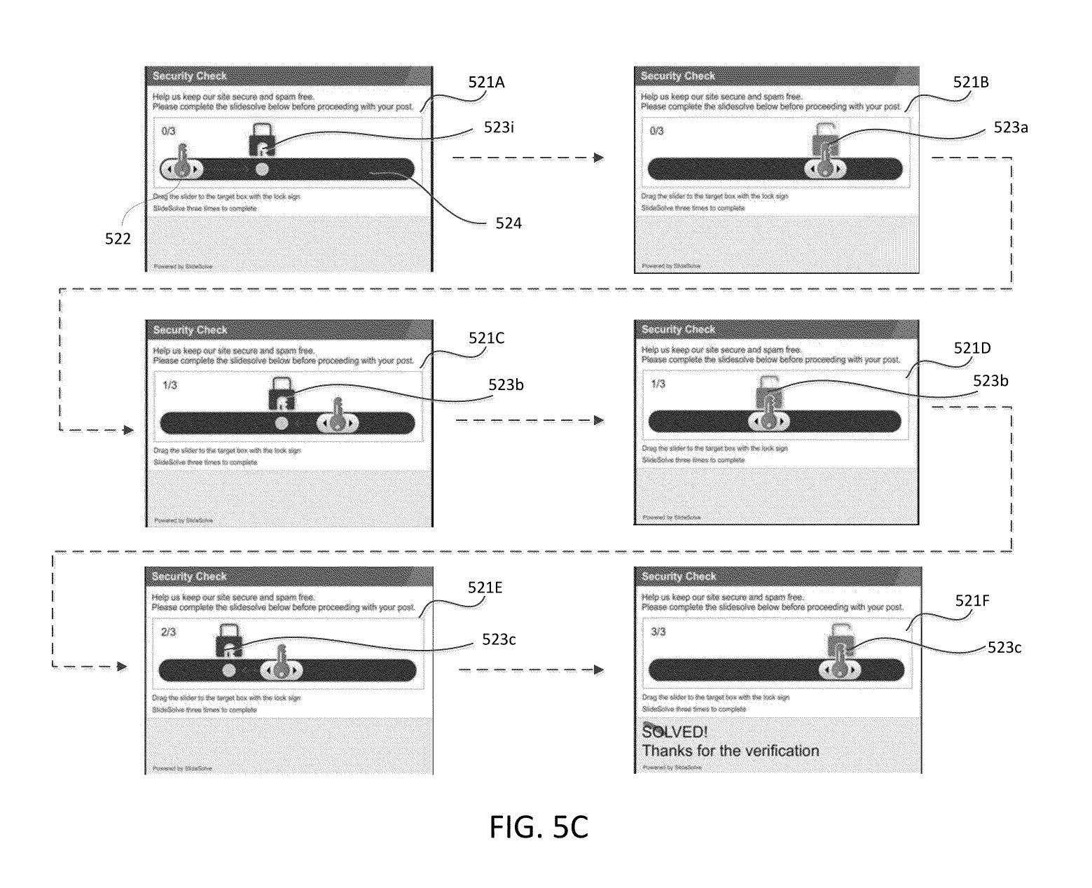

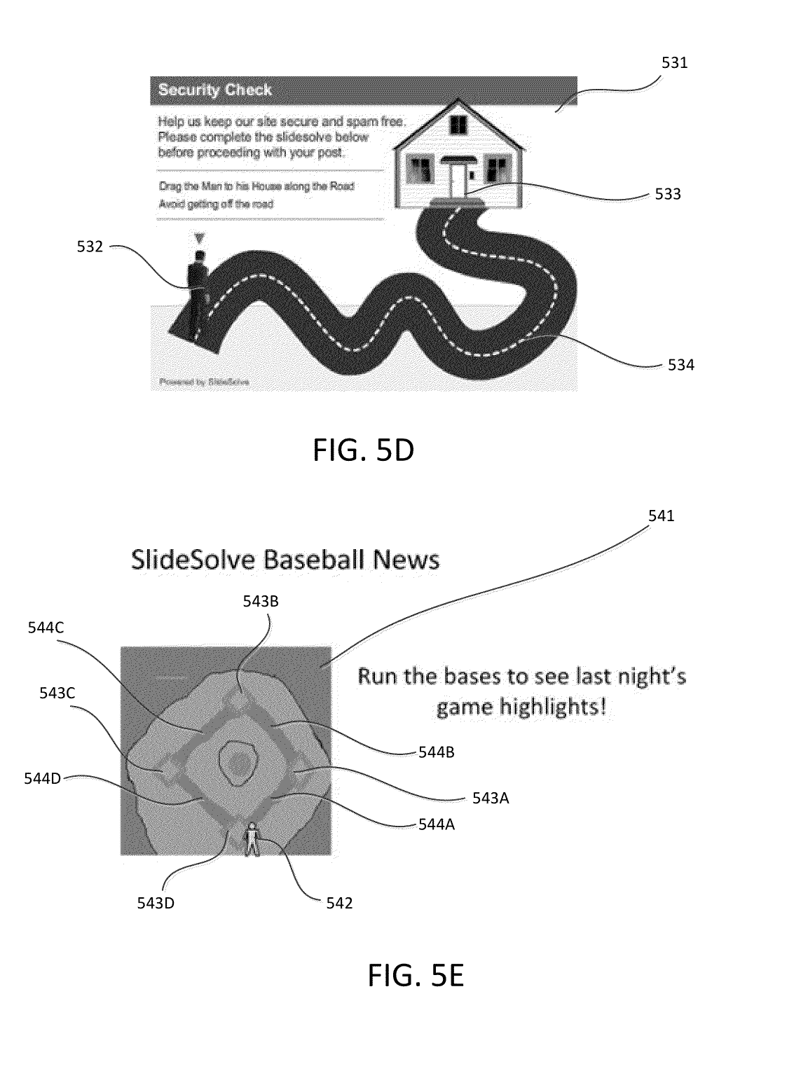

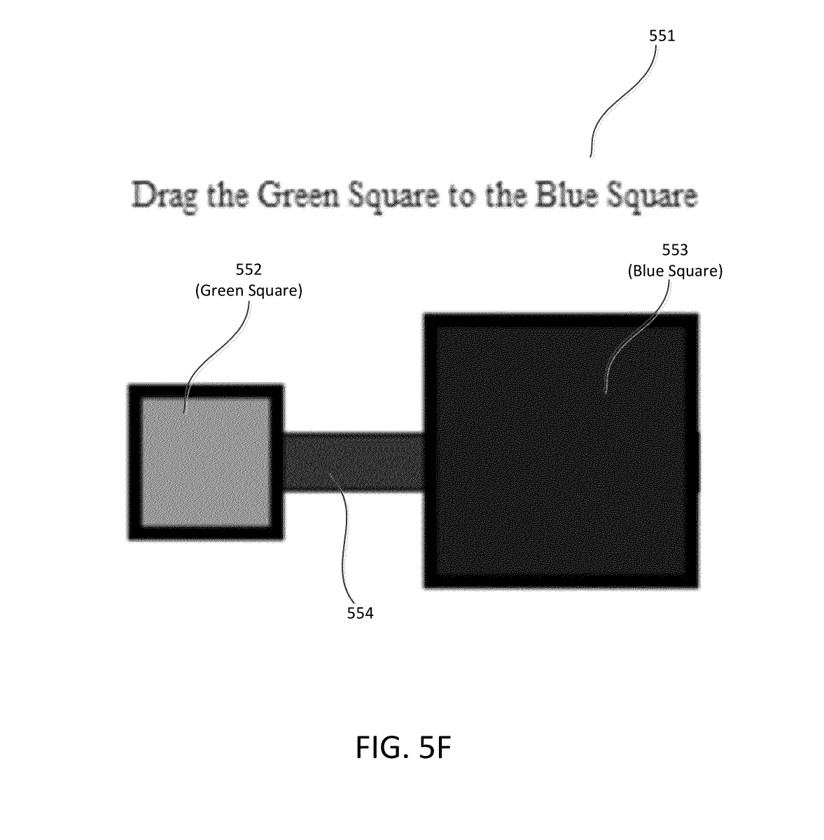

Before describing an exemplary underlying implementation of the disclosed AIDAPS system and method, it is first important to appreciate how AIDAPS puzzles are utilized to test for humanness. FIGS. 5A-E are pictorials illustrating exemplary AIDAPS puzzles, according to one or more embodiments of the present disclosure.

FIG. 5A illustrates one example of an AIDAPS puzzle 501 in accordance with one embodiment of the present disclosure. In this example, referring to pictorial 501A, a user is presented with graphics prompting user to “slide” a given thumbwheel (hereinafter also referred to as an “Actor” object or an “Actor”) from one end of a one-dimensional slider 504 to the other end of the slider in order for the user to get access to content that the user desires, such as playing a popular “angry birds” game. Puzzle 501 is so programmed that the user can “slide” the thumbwheel 502 through maneuvering an input pointing means, such as moving a mouse, or tapping and then moving one of the user's fingers on a touchscreen. Referring to pictorial 501B, as the user “slides” thumbwheel 502 to, for example, the other end of slider 504, the puzzle provides visual indication 505 that the user has successfully solved the puzzle. Subsequently, referring to pictorial 501C, the “angry birds” game is revealed, thus allowing the user to play the game. As will be discussed in more detail below, the disclosed system, which, in this case, utilizes the exemplary AIDAPS puzzle, is effective in terms of testing for humanness, and has several advantages over many conventional CAPTCHA systems.

First, the exemplary AIDAPS puzzle serves the purpose of testing for humanness while a user only needs to perform a very easy-to-perform task in order to have access to the content which the user desires. More specifically, the user is not required to answer any question or decipher any message, and is simply asked to “Slide to Reveal”, which is easy for a human to understand and perform. Although what requires for a user to pass the puzzle is visually indicated and apparent to a human user, the requirement is not apparent to a typical automated “drone”. Thus, as the user solves the puzzle by sliding the Actor 502 from one end of slider 504 to the other end of the slier, the user, in effect, proves that he/she is a human, and will be revealed and have access to the content he/she desires. On the other hand, a typical automated “drone”, not understanding what is required to solve/pass the puzzle, will be denied revealing of, and having access to, the content.

Second, at first glance, one might think that the disclosed system's test for humanness can be easily defeated through automation performed by malicious computer software attacks, such as JavaScript code injection, GUI automation, or similar attacks. However, the disclosed system is “concerned” not only about the ability of the user to “slide” the thumbwheel to a location corresponding to the answer to the question, but also about how the user slides the thumbwheel to a location corresponding to the answer to the question. To do this, the disclosed system uses behavior analysis algorithms which, for example, among other things, test for a “too perfect” (or non-human) solution. This added layer of behavior analysis makes it more difficult for an attacker to use automation to defeat the test for humanness. Therefore, the disclosed system cannot be easily defeated through automation.

Third, as also noted above, for many conventional CAPTCHA systems, users are required to input the deciphered message into an input field by typing keys on either a physical keyboard or a keyboard window (displayed on a touchscreen). By contrast, to solve the exemplary puzzle 501, a user only needs to maneuver an input pointing means (such as a mouse or a touchscreen) with easy-to-perform motions (such as moving a mouse, or tapping and moving a finger on a touchscreen), as opposed to being forced to type keys on a physical keyboard or a keyboard window displayed on a screen. To a typical user, the latter is significantly more onerous than the former. To demonstrate, if a relatively small touchscreen of a smartphone is used as the primary input means, the latter would require a user to first bring up a small keyboard window and then “type” those small characters on the small keyboard window, for which it is not uncommon that wrong characters were typed and had to been corrected during typing. The former, however, would only require a user to tap and move a finger on the touchscreen. Thus, to a human, the former (namely, maneuvering an input pointing means) is categorically easier than the latter (namely, being forced to type keys on a physical keyboard or a keyboard window displayed on a screen).

Accordingly, at least due to the above considerations, getting past the exemplary AIDAPS puzzle is significantly more user-friendly than getting past many conventional CAPTCHA systems while effectively serving the same purpose of proving humanness. Thus, the exemplary AIDAPS puzzle 501, or similar AIDAPAS puzzles, may be advantageously used by operator sites 102 (such as web sites) who would like to, e.g., either test for humanness in order to enhance online security or have a user to watch an advertisement with one or more ways to prove that the user has in fact paid attention the content of advertisement in order to receive advertising revenue from a paid advertiser, before revealing user-desired or user-requested content (such as a coupon code, a web page identified by a specific URL, a secret password, or a newspaper article) to an interested human user but not to an automated “drone” (such as a “bot”).

FIG. 5B illustrates another example of an AIDAPS puzzle 511 in accordance with one embodiment of the present disclosure. Hereinafter, to facilitate comparing components of one AIDAPS puzzle to corresponding counterpart components of another AIDAPS puzzle, components of one AIDAPS puzzle are assigned reference numerals or reference alpha-numerals having the same single digit as those of reference numerals or reference alpha-numerals assigned to corresponding counterpart components of another AIDAPS puzzle, respectively. As one example, “512” is assigned to the Actor (thumbwheel) of AIDAPS puzzle 511, in consideration of that “502” is assigned to the Actor (thumbwheel) of AIDAPS puzzle 501. As another example, “514” is assigned to the one-dimensional slider of AIDAPS puzzle 511, in consideration of that “504” is assigned to the one-dimensional slider of AIDAPS puzzle 501.

Puzzle 511, on one hand, is similar to the previous puzzle 501—in that they both require a user to “slide” an Actor object (thumbwheel) to solve and get past them so as to test for humanness—while, on the other hand, serves as an advertisement and requires a user to pay attention to the advertisement in order to solve a substantive but an easy-to-answer “challenge” question if attention is paid to the advertisement, so as to get past the advertisement.

In one implementation, puzzle 511 contains image and text conveying advertising messages and requires the user to answer a “challenge” question by sliding the thumbwheel 512 to select one of five different number icons lined above the one-dimensional slider 514. The answer to the question is deliberately made apparent to a human user through image and text displayed in the puzzle. However, the user, in most cases, would need to pay attention to the advertising messages to know which one of the five number icons to select as the answer to the question.

As the user “slides” thumbwheel 512 across sider 514 via his/her maneuvering of an input pointing means, when the thumbwheel is moved to and stopped at a location directly below one of the five number icons, the number icon (directly below which the thumbwheel is stopped) is visually highlighted as an indication of a potential selection. If the user selects the number icon (by, for example, releasing a pressed mouse button or taking a touch finger off a touchscreen), the user will not solve and get past the puzzle unless the selected icon is number icon 513 bearing a correct answer to the “challenge” question.

Thus, if a user indeed solves puzzle 501, the user, to a great extent, proves to the advertiser that the user did actually pay attention to the advertising messages. As such, this exemplary AIDAPS puzzle is effective in serving dual purposes of letting the user prove humanness and indicating to the advertiser that the user has paid attention to the advertising messages contained therein, which is an advantageous feature not otherwise available in many conventional CAPTCHA systems. Thus, the exemplary AIDAPS puzzle, or similar puzzles, may be advantageously used by advertisers (as advertisements)—who desire a high level of confidence that their respective advertisements have been paid attention to by a human, especially those advertisers who are billed based on whether a user has interacted with one of their displayed advertisements (such as clicking a link displayed in an advertisement)—to combat potential frauds committed through automated attacks, such as the so-called “click-fraud.”

FIG. 5C illustrates yet another example of an AIDAPS puzzle 521 in accordance with one embodiment of the present disclosure. In this example, a user is given a key 522 (hereinafter also referred to as an “Actor” object or an “Actor”) and a lock 523 positioned randomly along a one-dimensional slider 524. The user is challenged to “slide” the key into the lock (to unlock the lock) three times in a row to prove humanness. In one implementation, lock 523 appeared at an initial random location 523i on slider 524. The moment the puzzle discovers that the user “taps” key 522, the puzzle immediately has lock 523 jump to a first location 523a on slider 524. Referring to pictorial 521B, immediately after the user slides key 523 into lock 523 (positioned at location 523a) for the first time, the lock moves to a random second location 523b, indicating to the user that the user must now slide the key into the lock positioned at location 523b, or puzzle 521 stays unsolved. Thus, to prove humanness and get past the puzzle, referring to pictorials 521C-521F, the user must slide key 522 into lock 523 for the second time and later the third time in order to solve the puzzle.

To a human, sliding the key into the lock three consecutive times, which although is more onerous than sliding the key into the lock only once, is still fairly easy to do (e.g., compared to typing six or seven characters in a input field on the small smart phone screen as required in many conventional CAPTCHA systems). However, for malicious programmatic means aimed to solve AIDPAS puzzles using automated interactions, the complexity required for solving puzzle 521 (requiring three key-unlocks) may substantially increase, compared to the complexity required for solving an AIDAPS puzzle where only a single key-unlock is needed.

Besides, as similarly noted above, to test for humanness, the disclosed system, through using behavior analysis, is more “concerned” about how the user slides key 523 into lock 523 than whether the user manages to slide the key into the lock. Thus, this complexity increase is even more acute, now that compared to solving of a single-key-unlock AIDAPS puzzle, solving of the exemplary AIDPAS puzzle 521 may potentially generate three times as much behavior data of the user for behavior analysis in testing for humanness. Thus, compared to a single-key-unlock AIDAPS puzzle, the exemplary three-key-unlock AIDPAS puzzle, or other similar multi-key-unlock AIDPAS puzzles, can be effectively used to significantly enhance, e.g., web security.

FIG. 5D illustrates yet another example of an AIDAPS puzzle 531 in accordance with one embodiment of the present disclosure. In this example, a user is given a stick FIG. 532 (hereinafter also referred to as an “Actor” object or an “Actor”), a house 533 and a curved path 534, with the stick figure positioned at one end of the curved path and the house positioned at the other end of the curved path. The user is asked to “drag” stick FIG. 532 (understandably with an input pointing means (such as a mouse or touchscreen) or equivalent) to the house along the curved path and avoid the stick figure being “dragged” off the road in the process.

Similar to the three exemplary AIDAPS puzzles shown in FIGS. 5A-C, puzzle 531 only requires a user to do a series of maneuvering of or on an input pointing means (such as moving a mouse or tapping and moving one of his/her fingers on a touchscreen) to solve the puzzle. In the course of puzzle-solving, unlike the previous three exemplary AIDAPS puzzles, both of which only require the user to move an Actor 532 (either a thumbwheel or a key) along a linear or one-dimensional path (namely, a one-dimensional slider), this AIDAPS puzzle requires the user to move an Actor 532 (the stick figure) along a curved path—which is a non-linear two-dimensional path—in the process of “dragging” the Actor to the target location (the house location) without causing the Actor moved off the curved path.

To a human, moving an object (which, in this case is a stick figure) along a two-dimensional path (which, in this case, is a curved path) using an input pointing means, which although may be more onerous than moving an object along a linear or one-dimensional path, is still fairly easy to do. However, for malicious programmatic means aimed to solve AIDPAS puzzles using automated interactions, the complexity required for solving the exemplary “curved-path” AIDPAS puzzle may substantially increase, when compared to the complexity required for solving a “straight one-dimensional path” AIDAPS puzzle.

Besides, as similarly noted above, to test for humanness, the disclosed system is more “concerned” about how the user moves an Actor to a target location along a curved path to the target location than whether the user manages to move the Actor to the target location. Thus, this complexity increase is even more acute, now that compared to solving of a “straight-path” AIDAPS puzzle, solving of a “curved-path” AIDPAS puzzle may potentially generate more behavior data in quantity and/or behavior data better reflective of humanness, behavior data which can then be used for behavior analysis in testing for humanness. The increase in quality or quantity of the behavior data, e.g., results from a human's conscious decision not to “drag” the stick figure off the curved path. Thus, compared to a “straight-path” AIDAPS puzzle (such as puzzles 501, 511 and 521), puzzle 531 (or other similar “two-dimensional-path” AIDPAS puzzles) can be more effective in tests for humanness.

FIG. 5E illustrates yet another example of an AIDAPS puzzle 541 in accordance with one embodiment of the present disclosure. In this example, a user is given a stick FIG. 542 (hereinafter also referred to as an “Actor” object or an “Actor”) and diamond-shaped baseball field having four bases with the stick figure initially placed on the home base 543D of the baseball field. To solve and get past the puzzle, the user is asked to “drag” the stick figure so as to have the stick FIG. 542 “run” the bases 543A, 543B, 543C and 543D by moving sequentially along and through paths 544A, 544B, 544C and 544D.

Similar to the four exemplary AIDAPS puzzles shown in FIGS. 5A-D, puzzle 541 only requires a user to do a series of maneuvering of or on an input pointing means (such as moving a mouse or moving one of his/her fingers on a touchscreen) to solve the puzzle. In the course of puzzle-solving, unlike the previous three exemplary AIDAPS puzzles—each of which requires a user to move an Actor (e.g. a thumbwheel, key or stick figure) along and/or across a single path (regardless of whether the path be linear, one-dimensional or two-dimensional, or goes one or two directions)—this exemplary AIDAPS puzzle requires a user to move an Actor 542 (the stick figure) along and across multiple paths 544A, 544B, 544C and 544D (defined by different pairs of start and end locations) and “drop” the Actor at a series of target locations 543A, 543B, 543C and 543D (each of which may also be the start location of the succeeding path) in an order explicitly or implicitly indicated by the puzzle (as understood by a human).

To a human, moving an Actor (which, in this case is a stick figure) along and across multiple paths and “dropping” the Actor at a series of target locations (either in an order required by the puzzle or without any specified order) in the process, which although may be more onerous than moving an object along a single path, is still fairly easy to do. However, for malicious programmatic means aimed to solve AIDPAS puzzles using automated interactions, the complexity required for solving the exemplary “multi-path” AIDPAS puzzle may substantially increase compared to the complexity required for solving a “single-path” AIDAPS puzzle (regardless of whether the single path be straight or curved) is needed.

Besides, as similarly noted above, to test for humanness, the disclosed system is “concerned” about not only how the user “drops” an Actor at the series of ordered target locations (while moving the Actor along and across multiple paths) but also whether the user manages to “drop” the Actor at the series of target locations. Thus, this complexity increase is even more acute, now that compared to solving of a “single-path” AIDAPS puzzle, solving of a “multi-path” AIDPAS puzzle may potentially generate more behavior data in quantity and/or better behavior data in quality (in terms of reflecting humanness), behavior data which can then be used for behavior analysis in testing for humanness. The increase in quality and/or quantity of the behavior data, e.g., results from a human's conscious decision to move the Actor along each path and make the Actor have a brief stop at a series of required target locations in a particular order. Therefore, compared to a “single-path” AIDAPS puzzle, “multi-path” puzzle 541 (or other similar “multi-path” AIDPAS puzzles) can be more effective in tests for humanness.

As appreciated by a skilled artisan, myriad of AIDAPS puzzles differing in content and/or form from any of the exemplary AIDAPS puzzles illustrated in FIGS. 5A-E may be created without departing from the scope and spirit of the present application. As one example, a skilled artisan may decide to use a particular background for an AIDAPS puzzle. As another example, despite that many AIDAPS puzzles may only have one Actor object, a skilled artisan, however, may decide to include in an AIDAPS puzzle multiple Actor objects requiring each Actor object to be “dropped” to a different or same corresponding target location. As yet another example, a skilled artisan may modify the exemplary “three-key-unlocks” AIDAPS puzzle by deliberately placing a “fake” lock between the key and the target lock at the start or in the middle of puzzle-solving so as to create more “noise” for an automatic attack. As yet another example, a skilled artisan may modify the exemplary “running-the-bases” AIDAPS puzzle by rendering each “running” path curved. As yet another example, although AIDAPS puzzles do not typically require that a user type any text in the course of puzzle-solving, an AIDAPS puzzle requiring, in the course of puzzle-solving, that a user type text in addition to “moving” and/or “dragging” an object, also does not depart from the scope and spirit of the present application. As yet another example, although AIDAPS puzzles are understandably solved with maneuvering an input pointing means, an AIDAPS puzzle that can be solved without using an input pointing means while using another type of input device simulating typical maneuvers of an input pointing means, also does not depart from the scope and spirit of the present application. Additionally, although an AIDAPS puzzle has been shown to enhance online security or serve the advertising purpose, an AIDAPS puzzle may also be utilized for other purposes and objectives without departing from the scope and spirit of the present disclosure, so long as the AIDAPS puzzle is utilized to test for humanness and/or display a useful message.

### 3. Exemplary Implementations of System and Method Enabling AIDAPS Puzzles

### a. Exemplary Multi-Node Client-Server Based Architecture

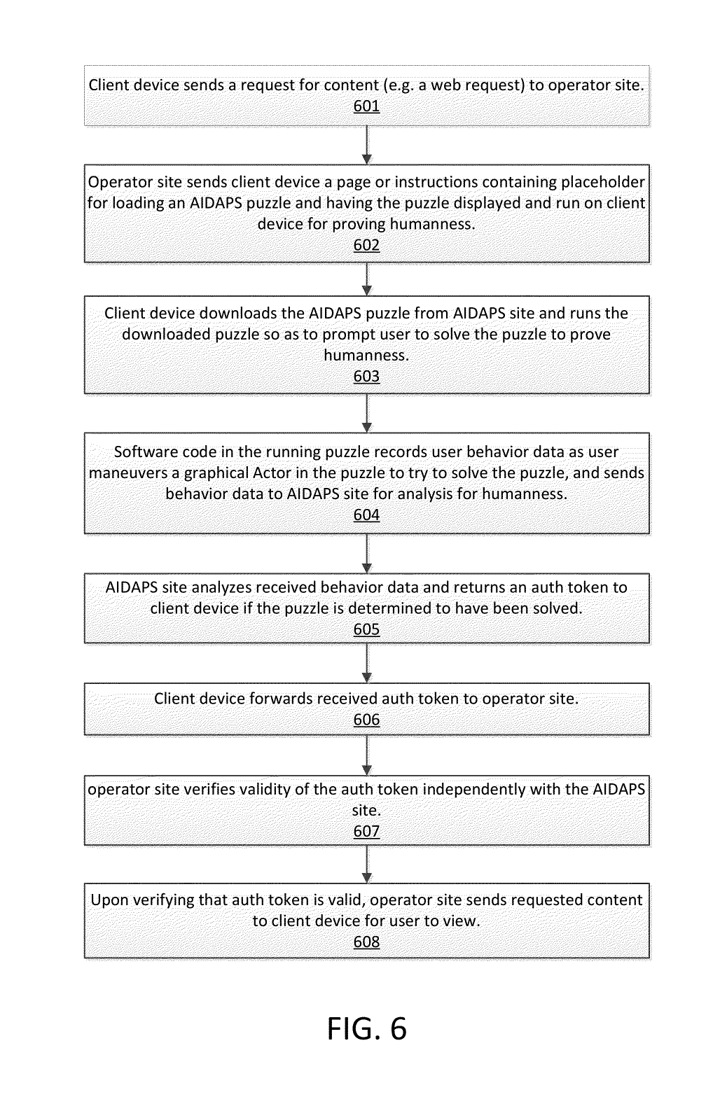

FIG. 6 is a flowchart illustrating a process in which an AIDAPS puzzle is employed and user behavior data collected during the course of solving of the puzzle is analyzed in testing for humanness before requested content is revealed to a requesting user, according to one or more embodiments of the present disclosure. As used herein, the terms “block” and “step” may be used interchangeably to refer to a set of programmatic code adapted to perform one or more specific functions when executed by one or more processors.

At block 601, a client device 101, via a client application 410, sends a request (such as a web request if the client application 410 is a browser 411) to an operator site 102 for, e.g., accessing specific content (which a user operating the client device desires to access).

At block 602, operator site 102, upon receiving the web request, instead of immediately sending the requested content to the client device as the response to the content request, may first choose to, for online (network) security purpose, test whether client device 101 is operated by a human, or for revenue generating purpose, show an advertisement to the user operating the client device, by sending a first UI (such as a web page) rendered to cause a particular AIDAPS puzzle displayed and run on the client device (via, e.g., an HTML page or instructions to render such an UI).

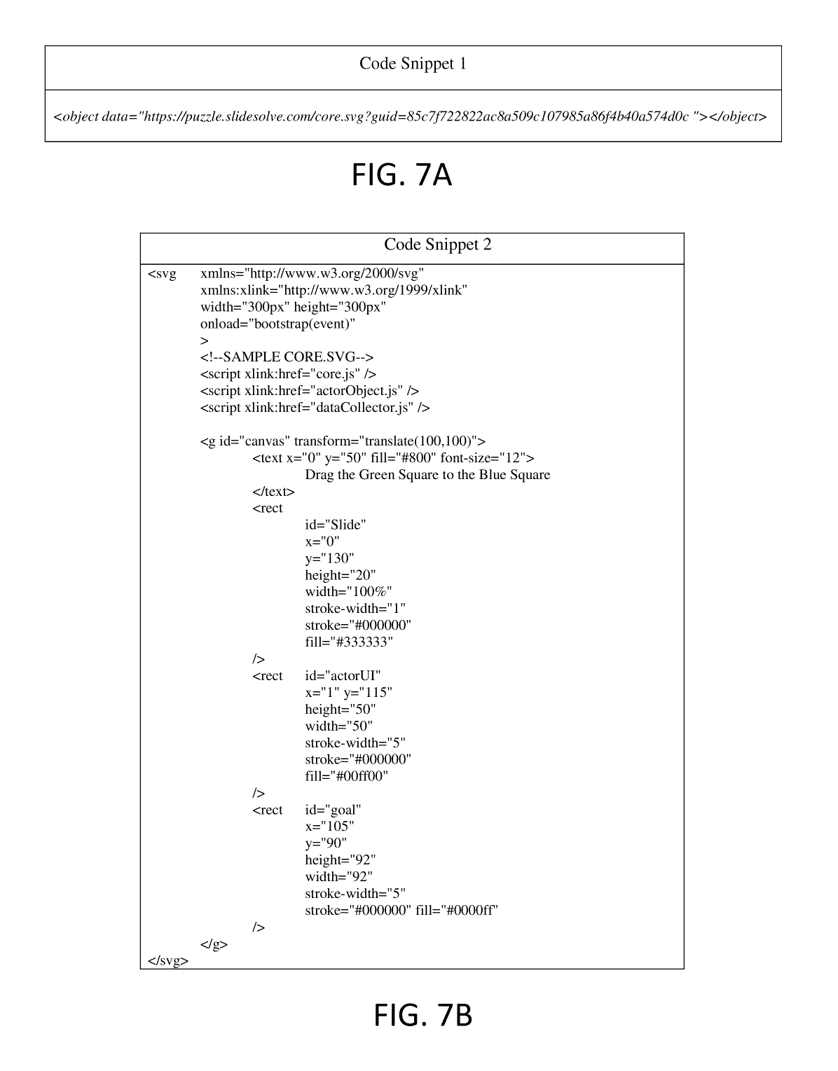

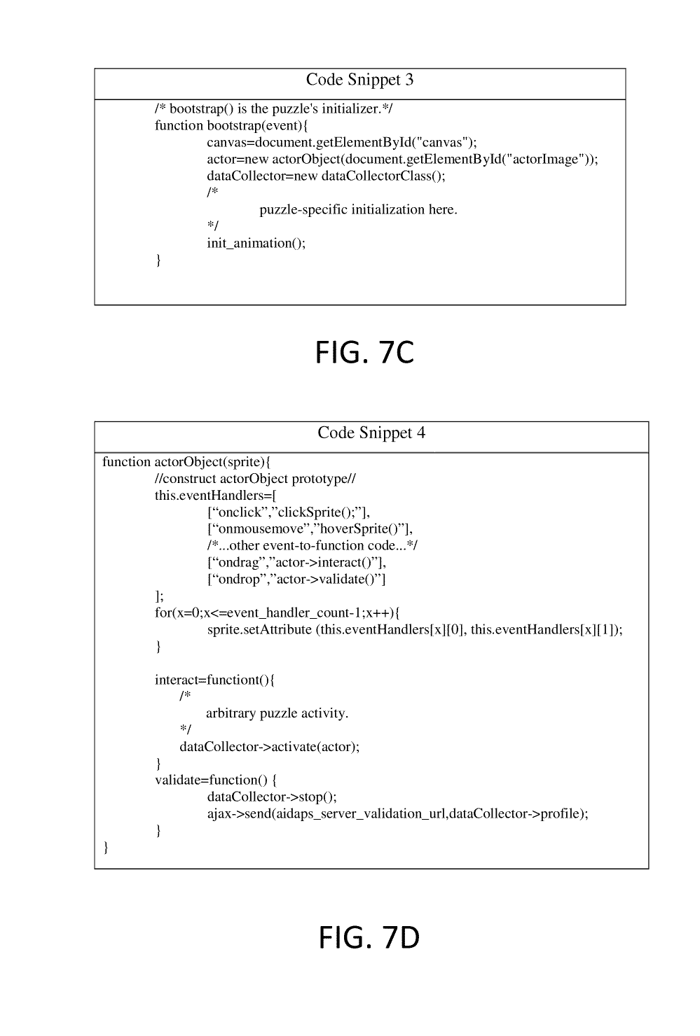

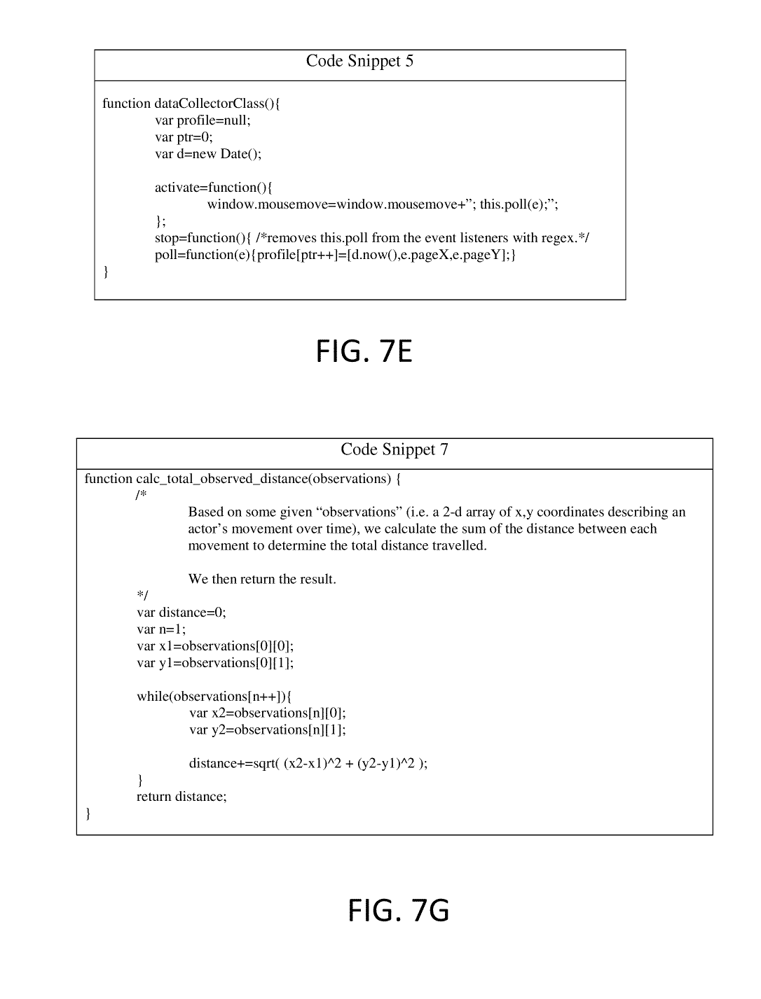

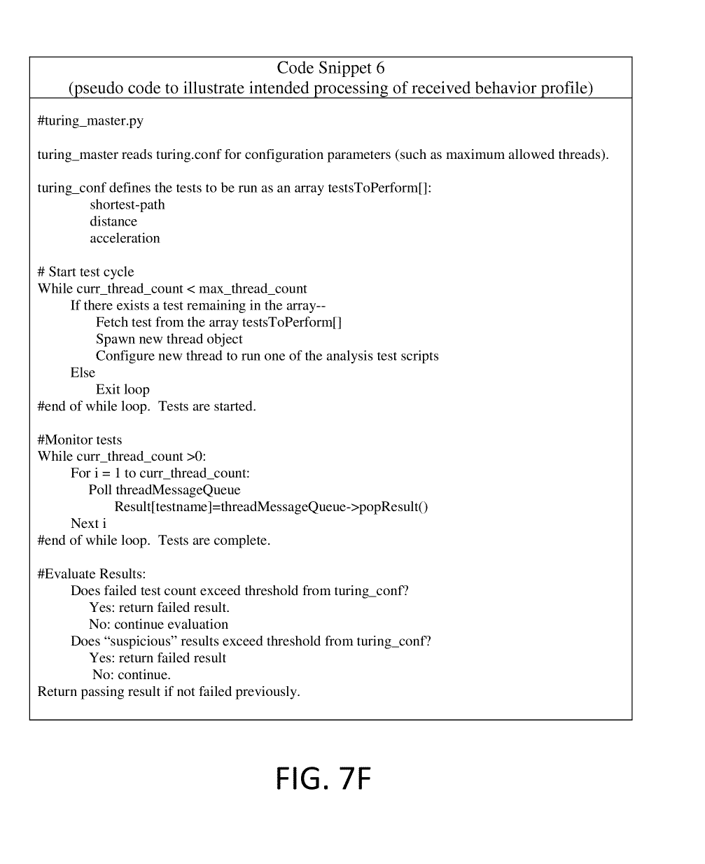

In doing so, operator site 102 places a custom “placeholder”—which operator site 102 may, e.g., obtain from a market place established for linking content providers to advertisers interested in running AIDAPS puzzles as a form of advertisements—in the first UI. The placeholder contains address information of a provider of AIDAPS puzzles—which, in this case, is server 201 of AIDAPS site 103—as well as information identifying the intended AIDAPS puzzle as understood by the AIDAPS server. Code snippet 1 illustrated in FIG. 7A is an example of such a placeholder. The custom placeholder may be site-specific and browser-specific.

At block 603, the client application 410 on the client device, upon receiving the first web page, renders this placeholder, causing the client application 410 to download an AIDAPS puzzle in a form of a software widget from AIDAPS site 103 (via server 201). AIDAPS server 201, upon receiving the download request, creates, or retrieves from DS 202, a requested AIDAPS puzzle (via, e.g., puzzle construction module 211) based on the AIDAPS puzzle identification information included in the placeholder, and sends the created or retrieved AIDAPS puzzle to the client application 410 so as to realize the downloading. The sent AIDAPS puzzle may be created by modifying an AIDAPS puzzle retrieved from DS 202.

By way of example and not limitation, the downloaded AIDAPS puzzle may be an SVG graphic image file containing programmatic code for, for example, rendering graphics—which may include background image as well as one or more individual graphic Actor objects (such as the thumbwheel or the stick figure in the respective exemplary AIDAPS puzzles shown in FIGS. 5A-E)—and enabling user interaction with rendered graphics (including interaction with one or more Actor objects).

At block 604, the programmatic code in the downloaded AIDAPS puzzle (on the client device 101) enables the user to interact with a graphical Actor object (hereinafter also referred to as “Actor”) in the render graphics. At this time, the puzzle-solving session starts. When the user “drags” the Actor (via an input pointing means), the interaction begins and a programmatic object linked to the Actor (hereinafter referred to as “actor”) starts to “record” its coordinates (time, x, y) using another programmatic object (which, for the purpose of illustration and not limitation, will be hereinafter referred to as a “dataCollector”). When the user “drops” the Actor (via an input pointing means), the actor sends the “recording” (which, for the purpose of illustration and not limitation, may be referred to as “behavior profile”) to the AIDAPS server for behavior analysis associated with the puzzle-solving. The sending of the behavior profile may be asynchronous (for example, via an AJAX request), and thus does not necessarily indicate the end of the puzzle-solving, especially where the puzzle requires the user to “drop” or move the Actor to a series of target locations. Thus, the user may continue to perform puzzling-solving activities as the behavior profile may be asynchronously sent to the AIDAPS site for analysis done in block 605. That is, block 604 may be performed before, after, concurrently, or in parallel with, block 605 described below.

At block 605, AIDAPS site 103, upon receiving the behavior profile (via server 201), analyzes the behavior profile (via, e.g., behavior analysis module 212), and returns an authentication token (hereinafter simply referred to as “auth token”) to the client device—which may indicate that the puzzle is correctly solved by a human and not by a drone—if the puzzle is determined to be solved by a human and not by a drone according to the conducted behavior analysis.

At block 606, the client device forwards the received auth token to operator site 102. The auth token may be sent by a client application 410 (such as browser 411 running on client device 101) to operator site 102 via an AJAX request.

Optionally, at block 607, as operator site 102 may choose to verify the auth token independently to avoid fraud at client application 410 of client device 101, the operator site sends a verification request (with respect to the auth token) to AIDAPS site 103, which responds with an answer as to whether or not the auth token is legitimate and not expired. Of course, if operator site 102 chooses not to verify the auth token independently, this block can be skipped.

In block 608, knowing that the AIDAPS puzzle has been solved by the human, as indicated by the possession of either a presumably valid auth token or an independently validated auth token, operator site 102 reveals the requested content (by retrieving the requested content from DS 302 via one or more business logic modules 312 and rendering the retrieved content via one or more GUI modules 313) and sends the rendered requested content to the client application 410 (via, e.g., web server module 311) so as to satisfy the user's initial content request.

### b. Exemplary Implementations of an AIDAPS Puzzle

By way of example and not limitation, an AIDAPS puzzle (e.g. rendered and run in a client browser 411) as part of the above-noted block 604) may be implemented using an SVG graphic with external references to browser-specific and puzzle-specific JavaScript and/or SMIL for animation and automation. Code snippet 2 illustrated in FIG. 7B is an example code snippet of SVG-XML that renders the graphics of an exemplary AIDAPS puzzle 551 shown in FIG. 5F. Alternatively, the AIDAPS puzzle may be rendered and run in another separate client application 410A having communication with the client application 410 which has downloaded the puzzle.

As indicated in code snippet 2, the displayed graphic is linked to three JavaScript files—namely, core.js, actorObject.js and dataCollectorjs—which define programmatic modules running in the client browser to render the graphic an AIDAPS puzzle.

JavaScript file core.js contains a function bootstrap( ). This function is executed when an AIDAPS puzzle is loaded, performing setup operations. As provided in code snippet 3 illustrated in FIG. 7C, this function obtains a handle to a “canvas” programmatic object, which is linked to the background image of an AIDAPS puzzle shown in FIG. 5F. Additionally, the function may instantiate two other programmatic objects—namely, the above-noted actor and dataCollector—and may perform other puzzle-specific initialization as needed.

As briefly noted above, the actor links a graphic Actor object (which, in this implementation example, is the green square 552 shown in FIG. 5F) to programmatic code (which, in this exemplary implementation, is included in actorObject.js) capturing user interaction with the Actor 552. Provided in code snippet 4 as illustrated in FIG. 7D, the code may include event handlers, which causes the actor call the actor->interact( ). As code snippet 4 indicates, the routine actor->interact( ) may perform puzzle-specific activities associated with the user's interaction (or, in other words, behavior) with the puzzle (including, for example, interaction with the Actor), and then calls the routine dataCollector->activate( ).

JavaScript file dataCollector.js contains programmatic code defining the dataCollector. As provided in code snippet 5 illustrated in FIG. 7E, the routine dataCollector->activate( ), when called by the routine actor->interact( ), “records” (or, in other words, collects) data indicative and/or reflective of behavior of the user. The user's behavior profile is thus established, and is formed of the behavior data collected by the dataCollector over the course of the user interaction with the puzzle in a puzzle-solving session.

Client device 101 (the client-side) and AIDAPS site 103 (hereinafter also referred to as “the server-side”) may communicate with each other through widget interaction there-between. In particular, as provided in code snippet 4, the actor of the client-side sends the server-side the user's behavior profile (through, for example, actor->validate( ) where an AJAX call directed to the server-side is called)—which may be provided in a form of an array of tuples containing the position and times of all mouse movements—when, for example, the client-side processing determines that the user has made an attempt to “drop” the Actor.

When the dataCollector activates, it may request from the server-side (AIDAPS site 103) a time-sensitive, one-time-use puzzle token (e.g., via an AJAX request). The lifetime of the puzzle token may be determined by the historical performance of human users for the same puzzle. When the dataCollector submits the “behavior profile” object to the server-side (AIDAPS site 103), it also includes the puzzle token. The server-side (AIDAPS site 103) may test the validity of the puzzle token to ensure it is legitimate and not expired. This may help prevent replay attacks and requires the user to complete the puzzle within a reasonable amount of time.

The server-side (AIDAPS site 103) processes the received behavior profile (via, e.g., behavior analysis module 212) by, for example, executing a programmatic behavioral analysis module (written, for example, in Python) called turing-master.py, whose pseudo code is provided in code snippet 6 for illustration and not for limitation. The behavior analysis module (which, may also be referred to as “behavior analysis engine”), when executed, calculates and analyzes, for example, the correlation between “perfect” solutions and the user's behavior (as indicated in the behavior profile)—which may include correlation between distance traveled, path selected and acceleration, as will be further disclosed below—and returns a result of the analysis indicating whether the AIDAPS puzzle has been solved by a human. If the result indicates that the AIDAPS puzzle has been solved by a human, the AIDAPS server-side may send an auth token to the client device, as indicated in the above-noted block 605.

The above-described implementations of an exemplary AIDAPS puzzle are merely exemplary. As appreciated by a skilled artisan, methodologies (as demonstrated in the above-described implementations) as well as similar implementations may be applied to the implementations of other exemplary AIDAPS puzzles, without departing from the scope and spirit of the present disclosure. As one example, the exemplary bootstrap( ) routine or similar/equivalent routine(s) may be customized to include puzzle-specific initialization. As another example, the exemplary actor->interact( ) routine or similar/equivalent routine(s) may be customized to include puzzle-specific handlings of various types of user interactions. As yet another example, the exemplary dataCollector->poll( ) routine or similar/equivalent routine(s) may be customized to include puzzle-specific behavior data collection functions.

### c. Exemplary Implementations of Behavioral Analysis for AIDAPS Puzzles

As disclosed above, in its test for humanness, the disclosed system is “concerned” about how, or in other words, the manner in which, an AIDAPS puzzle is solved, in addition to whether an AIDAPS puzzle is solved. The former is determined using the behavioral analysis of and/or on a user's behavior profile formed of the behavior data observed and “recorded” (collected) over the course of the user interaction with the puzzle. Generally, the behavioral analysis comprises a set of algorithms known and maintained on the server-side, an arrangement aimed to protect the integrity of the disclosed system.

### Distance-Travelled Test

A distance-travelled test may be included in the behavior analysis used for an AIDAPS puzzle. The test may start by calculating the shortest path an Actor (such as a thumbwheel or a stick figure as illustrated above) must move to complete its interaction with a target. This is a “perfect solution.” The distance of this perfect solution is compared to the total observed distance travelled by the Actor in the AIDAPS puzzle. An exemplary implementation of the test is provided in code snippet 7 as illustrated in FIG. 7G.

The following exemplary rules may determine humanness by the calculated distance travelled.

First, if (distance_travelled<perfect_distance)—which indicates that the Actor has never reached an intended target—then a first state indicating that puzzle is not solved correctly is returned.

Second, if (distance_travelled==perfect_distance)—which indicates that the solution provided by the client-side is perfect—then a second state indicating that statistically the user is most likely not human is returned.

Third, if the absolute value of (perfect_distance−distance_travelled) is larger than the suspicious_threshold_distance (or, in other words, (|perfect_distance−distance_travelled|>suspicious_threshold_distance))—which indicates that the Actor seems to have traveled too long a distance—then a third state indicating that the humanness on the client-side is suspicious is returned.

Fourth, if it is none of the above three scenarios—which indicates that the test cannot disprove humanness—then a fourth state indicating that the test is a pass is returned.

These four states may be returned to the controlling test function and aggregated. Each test may be given a weight based on historical data, and each result may be evaluated by the behavior analysis module (engine) to determine how much of that test's assigned weight may be given to the overall humanness determination.

### Path Correlation Test

A path correlation test may be used as part of the behavior analysis used for an AIDAPS puzzle. In this test, data of a chosen known baseline path and data of a subject path are compared using a “product-moment correlation coefficient” of their overall paths to solution. A “product-moment correlation coefficient” may be evaluated using the formula:

r=Σ(xy)/sqrt[(Σx²)*(Σy²)], where r is the correlation factor.

The shortest path between a starting point and ending point may be chosen as the baseline path. So the test becomes shortest-path correlation test. A distance-travelled test and the shortest-path correlation test may seem redundant, but they are complementary. Where shortest path measures the correlation of observed data to a known perfect path to the solution, total distance travelled accounts for “steps back” along the way. Both can be used in combination to help prove the presence of an imperfect human user.

In the shortest-path correlation test, the starting and required ending points to solve the puzzle are known, which are herewith locally referred to as A and B in the context of this test. The shortest distance between A and B is a line which passes through both. Thus, the perfect solution is a line which follows y=m(A,B)x+b(A,B), where m(A,B) and b(A,B) are functions to calculate the slope and y-intercept of the line between points A and B, respectively.

Using the formula y=m(A,B)x+b(A,B) for every observed x-coordinate value in the underlying behavior profile, a line from point A and the point where the Actor came to rest when the interaction ended is drawn. Then, the above-noted correlation coefficient (r) between the observed data and this calculated “too perfect” solution is calculated. Below is how the test may return a result based on the value of coefficient (r):

First, if (r<0)—which indicates that the Actor travelled anywhere but toward the target—then the test returns a result indicating that the received puzzle solution is incorrect.

Second, if (r==1)—which indicates that the received puzzle solution corresponds perfectly and thus indicates a non-human user—the test returns a result indicating that that the user on the client-side attempting to solve the puzzle is a non-human user.

Third, if (r>suspicious_threshhold_path)—which indicates that the solution exceeds historical expectations—then the test returns a result indicating that humanness on the client-side is suspicious.

Fourth, if else—which indicates that user is probably human—then the test returns a result indicating humanness on the client-side.

### Acceleration Test

An acceleration test may be used as part of the behavior analysis used for an AIDAPS puzzle. An acceleration test is similar to a shortest-path correlation test. Here the server-side calculates the time required to move through a path from one point A to another point B. If, for example, the Actor was observed at points A, B and C at time t={0, 1, 4}, respectively, then the velocity of the Actor each point can be calculated. From the change in velocity we find the Actor's acceleration.

In a human user, some variations in acceleration would be expected. But in an automated solution, an instantaneous acceleration between t=0 and t=1 and an instantaneous deceleration at t=n−1 and t=n (where the travel required n-seconds) would be expected, while no change in velocity between t=1 and t=n−1 would be expected. This is an improbable “perfect” solution where a GUI automation attack is used. For an AIDAPS puzzle where an Actor must travel n pixels to the target, if an impossible “light-speed” acceleration (a)—where a=n between t=0 and t=1 and a complete deceleration at t=n—is observed from the behavior profile, then an automated attack, such as a code-injection attack that simply changes the position of the Actor, is suggested, since such a teleportation of an Actor to target is impossible for human users.

### Historic Data Tracking

Historic data tracking (performed using the behavior profile) may be used as part of the behavior analysis used for an AIDAPS puzzle. Over time, the server-side (AIDAPS site 103) may build database(s) of historical data (in e.g., DS 202) about user behavior (for example, identified by any or a combination of IP address, browser characteristics, puzzles completed, behavior profiles, publisher and sales campaigns, etc.). The historical user behavior information may be mined and fed back into the behavior analysis module and as a way to track “reputation” of certain identified suspicious user behavior. This approach can be effective against malicious automated attacks, as demonstrated by the next example.

It is known that it is possible for distributed “bots” to inject JavaScript code into a web page's Document Object Model (DOM). An automated attack can be launched against an AIDAPS puzzle by programming the injected JavaScript code so as to make the puzzle-solving looked like done by a human. As one example, the injected JavaScript code may be so programmed that such code can “find” and “move” an Actor object of an AIDAPS puzzle (hosted by the web page) on the screen in accordance with pre-recorded human behaviors (for example, sliding a thumbwheel from left to right or moving a stick figure along a curved path and dropping the stick figure in the house at the end of the path). As another example, the injected JavaScript code may inject into a bogus behavior profile (which may be created with pre-recorded human behaviors) into the dataCollector object of the AIDAPS puzzle.

Tests, such as “distance-travelled test” or “path-correlation text”, may not be effective against such automated attacks, since the received behavior profile indeed corresponds to (pre-recorded) human behaviors. However, “historical data tracking” can be effective against suck attacks.

In particular, such automated attacks usually give away a recordable and traceable characteristic: a specific human behavior signature (user characteristic). With the historical data tracking, once the server-side collects sufficient human data, a specific human behavior signature (user characteristic) can be identified. This user characteristic can then be profiled against, for example, the server-side database (for example, storing historical behavior profiles of users) to identify suspicious patterns.

For example, let us assume that, based on historical data, it is discovered that some user characteristic has emerged, which solves an AIDAPS puzzle in Dallas, Tex. three times on Monday morning while solves an AIDAPS puzzle from a client in Moscow on Monday evening. The server-side, based on historical data associated with the user characteristic, could, for example, test for geographic distance and determine that no human being could possibly have been in Dallas and Moscow at the same time. It could be argued that the user was working from Dallas by remote access to lead a web conference in Moscow. Thus, a single incident may not justify an absolute ban of the user. Instead, the user's characteristic may, for example, have some numerical “reputation” score decremented. If the user (of the user characteristic) is in Dallas, then most of his/her traffic would likely originate from the client in the user's home town. This would eventually restore the lost reputation.

However, if the user characteristic is in fact that of a “malicious drone” used for automated attacks, historical data associated with the user characteristic, over time, would reveal uncommon, unreasonable, and/or illogical aspect(s) thereof. In the same “Dallas” example, if the user characteristic has indeed been used for automated attacks from geographically distributed “bots”, then the geographic distribution of activities of the user characteristic, over time, would appear pseudo-random. As a result, the “reputation” of the user characteristic would continue to fall and eventually fall to a level that allows the server-side to fail any AIDAPS puzzle solution having the user characteristics, thereby thwarting future automated attacks using the user characteristic.

### d. Exemplary Implementations for Strengthening Integrity of AIDAPS Puzzles

The disclosed system may also comprise implementations aimed to strengthen the integrity thereof.

First, keeping proprietary operations of the disclosed system on the server-side may help strengthen the integrity of the disclosed system. The disclosed system secures the server-side to keep proprietary processes from prying eyes. The behavior analysis module (engine) for an AIDAPS puzzle may be kept on the server-side, so that, for example, the analysis module can be adjusted or updated as needed without any attacker's knowledge so as to thwart newly discovered automated attacks targeting the AIDAPS puzzle. Thus, by keeping proprietary operations on the server-side, the disclosed system may effectively thwart and/or discourage automated attacks against AIDAPS puzzles, thus achieving web security for operator sites and/or giving confidence to advertisers.

Second, the disclosed system may encrypt communication between a client-side and the server-side to prevent replay attacks. Additionally, as described above, time-sensitive one-time tokens may be utilized to prevent or defeat browser-based replay attacks. With these measures, attackers may be further discouraged to devise and launch automated attacks against the disclosed system, as devising and launching automated attacks become even less cost-effective.

Third, client-side programmatic code, such as JavaScript code, may be obfuscated by one of many randomly-selected algorithms. Obfuscation may occur dynamically on the server-side as part of an overall implementation framework. For example, before the code intended to be run on the client-side is transmitted from the server-side, the intended client-side code, which may include but is not limited to JavaScript, CSS, SVG and other text-based content of a puzzle, may be rendered by the server-side through a preprocessor (such as a PHP preprocessor). This preprocessor may “scramble” the intended client-side code by, for example, altering variable names and other identifiers with each instance and/or encoding text-based content (with, for example, BASE64 encoding), thereby making an attacker's attempts at reverse engineering the puzzle difficult.

As appreciated by a skilled artisan, various changes may be made to the disclosed system and equivalents may be substituted for elements thereof without departing from the scope of the disclosure. As one example, the content request which the client device sends to an operator site 102 may be sent using proprietary protocols, rather than standard protocols used by a web request. As another example, an AIDAPS puzzle may be rendered in a host environment other than the browser environment described above. For example, the AIDAPS puzzle may be implemented in other forms, such as a standalone application running on a PC, smartphone and/or tablet. As yet another example, rendering of an AIDAPS puzzle may be implemented using graphics rendering technologies other than the SVG technology used in the examples described above, as long as the utilized graphics rendering technologies can render any graphics of choices as integral part of the AIDAPS puzzle. Similarly, user interaction, building of user behavior profile, and/or behavior analysis may be implemented using programming languages other than the SVG, JavaScript or Python programming languages noted above, as long as the used programmatic code can achieve same or similar functional objectives. As yet another example, the behavior analysis may use algorithms other than those described above as long as the used algorithms are designed to test for humanness by utilizing a received behavior profile.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof.

Therefore, it is intended that the disclosure not be limited to the particular embodiments disclosed for carrying out this disclosure, but that the disclosure will include all embodiments falling within the scope of the appended claims.

What is claimed is:

1. A method of detecting and preventing automated interaction, the method comprising the steps of:
a server sending a puzzle to a client application of a client device, said puzzle configured to enable a user to solve the puzzle with doing one or a series of maneuvers only using an input pointing means and by moving an Actor object displayed in the puzzle along an indicated path to a target location on the path;
the server receiving from the client application user behavior data documenting the user's interactions with the Actor object in the course of trying to solve the puzzle, analyzing the received user behavior data, and deciding whether the puzzle is solved and the puzzle is solved by a human based on the analyzing; and
the server sending to the client application an authentication token when the server deciding that the puzzle is solved by a human.
